(19) United States
(12) Patent Application Publication
(10) Pub. No.: US 2008/0256428 A1
(43) Pub. Date: Oct. 16, 2008

(54) System for facilitating the preparation of a patent application with an automatically variable omnibus form paragraph

(76) Inventor: Harold W. Milton, Bloomfield Hills, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/729,479

(22) Filed: Mar. 29, 2007

(51) Int. Cl. G06F 17/28; G06F 15/00

(52) U.S. Cl. 715/200

(57) ABSTRACT

A method of preparing a patent application in conjunction with a word processing program. Key explanations/disclaimers are inserted into an omnibus form paragraph in response to keys being found in the claims. This increases efficiency in the drafting of the patent application and prevents mistakes by ensuring that the omnibus form paragraph contains the necessary disclaimers/explanations for the style of claims in the patent application.

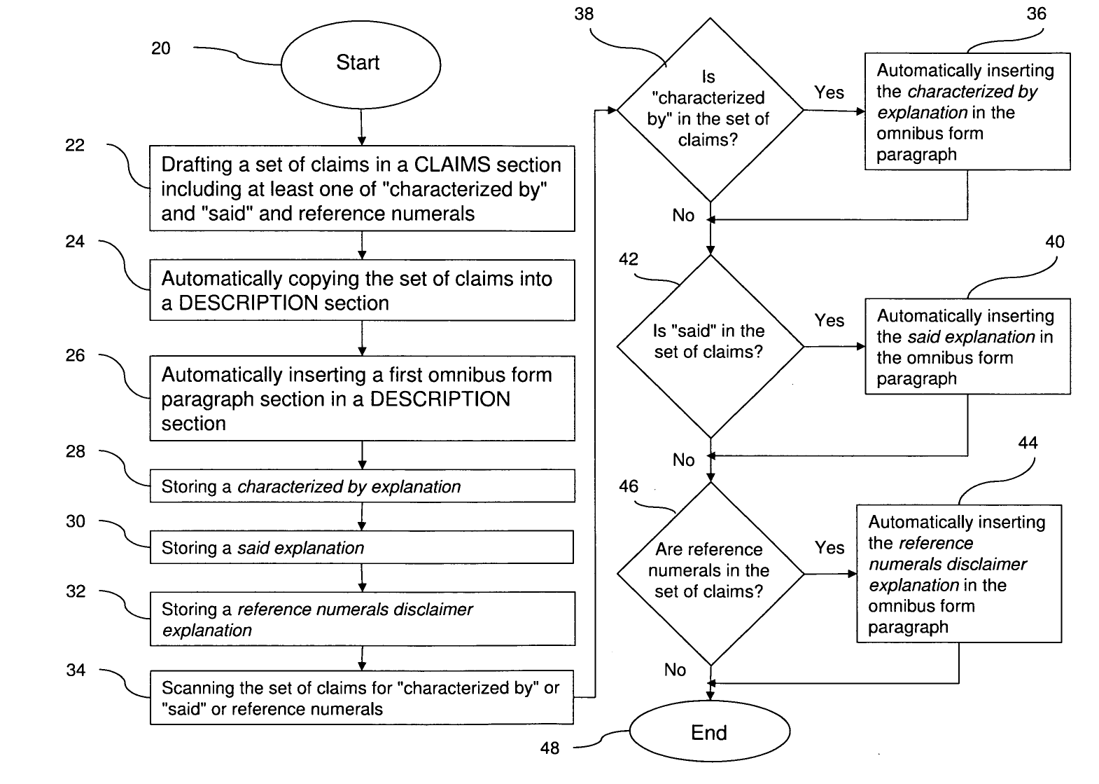

### CROSS REFERENCE TO RELATED APPLICATIONS

This application is related to application Ser. No. 09/273,021 filed Mar. 19, 1999 and application Ser. No. 11/300,207 filed Dec. 14, 2005.

### BACKGROUND OF THE INVENTION

1. Field of the Invention

A method of preparing a patent application in conjunction with a word processing computer program.

2. Description of the Prior Art

U.S. Pat. No. 6,049,811 discloses a computer program for facilitating the preparation of a patent application. This computer program assists the draftsman in drafting the various sections of a patent application including the DESCRIPTION section and automatically inserts a predetermined omnibus form paragraph at the end of the DESCRIPTION section of the patent application.

A method of preparing a patent application is disclosed in U.S. patent application Ser. No. 09/273,021, filed Mar. 19, 1999, in the name of one of the inventors herein. That method includes the step of drafting at least one claim in a CLAIMS section of a patent application and duplicating the claim(s) into a DESCRIPTION section of the patent application. This invention is a further perfection of the steps set forth in the aforementioned method.

### SUMMARY OF THE INVENTION AND ADVANTAGES

The invention provides a method for preparing a patent application including a CLAIMS section and a DESCRIPTION section using a computer program. The method is characterized by the computer program scanning a claim in the CLAIMS section for a key and then automatically inserting a key explanation in an omnibus form paragraph at the end of the DESCRIPTION section in response to the presence of the key in the claim.

The invention also provides a system for facilitating the preparation of a patent application including a CLAIMS section and a DESCRIPTION section. The system is characterized by a scanning processor for surveying a claim in the CLAIMS section for a key. A key processor inserts a key explanation in an omnibus form paragraph at the end of the DESCRIPTION section in response to the scanning processor detecting the key in the claim.

This invention brings order to the preparation of a patent application and increases efficiency in the preparation of patent applications by providing alternatives in drafting the claims and automatically varying the omnibus paragraph in response to the style of presentation in the claims. It automates part of the preparation of patent applications, but more importantly, it prevents mistakes by ensuring that the omnibus form paragraph contains the necessary disclaimers/explanations for the style of claims in the patent application.

### BRIEF DESCRIPTION OF THE DRAWINGS

Other advantages of the present invention will be readily appreciated, as the same becomes better understood by reference to the following detailed description when considered in connection with the accompanying drawings wherein the FIGURE is a flow chart of the invention.

### DETAILED DESCRIPTION OF THE INVENTION

Referring to the FIGURE, wherein like numerals indicate corresponding parts throughout the several views, a method of preparing a patent application in conjunction with a computer program is shown in the form of flow charts indicating the steps used to automatically build an omnibus form paragraph based on key elements being found in a set of claims.

The method starts 20 with the step of drafting 22 a set of claims into a CLAIMS section and including a key defined by at least one of “characterized by” and “said” and reference numerals for respectively separating prior art from novelty and designating previously recited elements and referencing elements to a drawing. It is to be appreciated that other terms or symbols may be defined as keys within the scope of the present invention.

The method proceeds with the computer program storing a duplicate set of the claims in the computer program and copying 24 the duplicate set of claims into a description section under the heading “DESCRIPTION OF THE PREFERRED EMBODIMENT.” The method continues with the computer program automatically inserting 26 a first sentence of an omnibus form paragraph at the end of the description section to affirm the definition of the invention, for example: “Obviously, many modifications and variations of the present invention are possible in light of the above teachings and may be practiced otherwise than as specifically described while within the scope of the appended claims.” It is understood that varied language can be used for the first sentence of the omnibus form paragraph is within the scope of the present invention.

The method continues by storing a characterized by explanation 28, which separates the prior art from the novelty in the claim, for example: “That which is prior art in the claims precedes the novelty set forth in the ‘characterized by’ clause. The novelty is meant to be particularly and distinctly recited in the ‘characterized by’ clause whereas the antecedent recitations merely set forth the old and well-known combination in which the invention resides. These antecedent recitations of prior art should be interpreted to cover any combination in which the inventive novelty exercises its utility.” It is to be understood that equivalent language may be used to explain the function of the “characterized by” clause in separating old from new within the scope of the present invention.

The method continues by storing an antecedent explanation 30 for antecedent checking, for example: “The use of the word ‘said’ in the claims refers to a previously-recited claimed feature and/or element (i.e. an antecedent) that is a positive recitation meant to be included in the coverage of the claims whereas the word ‘the’ precedes a previously-recited unclaimed feature and/or element that is not meant to be included in the coverage of the claims.” It is to be understood that equivalent language can be used to explain the use of the word “said” as it appears in the CLAIMS section in relation to the use of the word “the” within the scope of the present invention.

The method continues by storing a reference numerals disclaimer explanation 32, for example: “In addition, the reference numerals in the claims are merely for convenience and are not to be read in any way as limiting.” It is to be understood that other language can be used to describe the use of reference numerals to refer to elements in the drawings of the patent applications within the scope of the present invention.

The method is characterized by scanning the claim for “characterized by” and “said” and reference numerals 34. The computer program proceeds by automatically inserting 36 the characterized by explanation in the omnibus paragraph in response to “characterized by” being found 38 in the claims and automatically inserting 40 the antecedent explanation in the omnibus paragraph in response to “said” being found 42 in the claims and automatically inserting 44 the reference numerals disclaimer explanation in the omnibus paragraph in response to reference numerals being found 46 in the claims. Upon forming the omnibus paragraph automatically in response to the keys in the claims, the method ends 48.

The invention also includes a system for preparing a patent application including a CLAIMS section and a DESCRIPTION section. The CLAIMS section includes a claim and the DESCRIPTION section includes an omnibus form paragraph.

The omnibus form paragraph of the DESCRIPTION section includes a first omnibus form paragraph sentence defined by “Obviously, many modifications and variations of the present invention are possible in light of the above teachings and may be practiced otherwise than as specifically described while within the scope of the appended CLAIMS

The claim of the CLAIMS section includes a first key defined by “characterized by” and a second key defined by “said” and a third key being a reference numeral. The system includes a first key explanation further defined as a characterized by explanation for explaining the use of “characterized by” in the patent application. The characterized by explanation approximates “That which is prior art in the claims precedes the novelty set forth in the ‘characterized by’ clause. The novelty is meant to be particularly and distinctly recited in the ‘characterized by’ clause whereas the antecedent recitations merely set forth the old and well-known combination in which the invention resides. These antecedent recitations of prior art should be interpreted to cover any combination in which the inventive novelty exercises its utility.” The system includes a second key explanation further defined as an antecedent explanation for explaining the use of “said” in the patent application. The antecedent explanation approximates “The use of the word ‘said’ in the claims refers to a previously-recited claimed feature and/or element (i.e. an antecedent) that is a positive recitation meant to be included in the coverage of the claims whereas the word ‘the’ precedes a previously-recited unclaimed feature and/or element that is not meant to be included in the coverage of the claims.” The system also includes a third key explanation further defined as a reference numerals disclaimer explanation for explaining the use of the reference numeral in the patent application. The reference numerals disclaimer explanation approximates “In addition, the reference numerals in the claims are merely for convenience and are not to be read in any way as limiting.”

The system is characterized by a scanning processor for surveying the claim of the CLAIMS section for the first key and the second key and the third key. A first key processor inserts the characterized by explanation in the omnibus form paragraph of the DESCRIPTION section in response to the scanning processor detecting the first key in the claim. A second key processor inserts the antecedent explanation in the omnibus form paragraph in response to the scanning processor detecting the second key in the claim. A third key processor inserts the reference numerals disclaimer explanation in the omnibus form paragraph in response to the scanning processor detecting the third key in the claim.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A method of preparing a patent application including DESCRIPTION and CLAIMS sections by using a computer program comprising the steps of:
presenting an omnibus form paragraph preceding the CLAIMS section,
drafting a claim in the CLAIMS section including at least one key,
storing a key explanation describing the use the key,
characterized by scanning the claims for the key,
automatically inserting the key explanation in the omnibus form paragraph in response to the presence of the key in the claim.

2. A method as set forth in claim 1 further including drafting a claim in the CLAIMS section including a second key,
storing a second key explanation describing the use of the second key, and
automatically inserting a second key explanation in the omnibus form paragraph in response to the presence of the second key in the claim.

3. A method as set forth in claim 1 further including storing “characterized by” as the key.

4. A method as set forth in claim 3 further including storing a characterized by explanation as the key explanation verifying separation of old from novelty and approximating “That which is prior art in the claims precedes the novelty set forth in the ‘characterized by’ clause. The novelty is meant to be particularly and distinctly recited in the ‘characterized by’ clause whereas the antecedent recitations merely set forth the old and well-known combination in which the invention resides. These antecedent recitations of prior art should be interpreted to cover any combination in which the inventive novelty exercises its utility.”

5. A method as set forth in claim 1 further including storing “said” as the key.

6. A method as set forth in claim 5 further including storing an antecedent explanation as the key explanation for antecedent checking and approximating “The use of the word ‘said’ in the claims refers to a previously-recited claimed feature and/or element (i.e. an antecedent) that is a positive recitation meant to be included in the coverage of the claims whereas the word ‘the’ precedes a previously-recited unclaimed feature and/or element that is not meant to be included in the coverage of the claims.”

7. A method as set forth in claim 1 further including storing reference numerals for referencing elements in a drawing as the key.

8. A method as set forth in claim 7 further including storing a reference numerals disclaimer explanation as the key explanation and approximating “In addiction, the reference numerals in the claims are merely for convenience and are not to be read in any way as limiting.”

9. A method of preparing a patent application with a computer program comprising the steps of:
drafting a set of claims including a key defined by at least one of “characterized by” and “said” and reference numerals for respectively separating prior art from novelty and designating previously recited elements and referencing elements to a drawing,
storing a duplicate set of the claims in a computer program and copying the duplicate set of claims into a description section under the heading “DESCRIPTION OF THE PREFERRED EMBODIMENT,”
inserting a first sentence in an omnibus form paragraph at the end of the description to affirm the definition of the invention and approximating “Obviously, many modifications and variations of the present invention are possible in light of the above teachings and may be practiced otherwise than as specifically described while within the scope of the appended claims.”,
storing as a characterized by explanation verifying separation of old from novelty and approximating “That which is prior art in the claims precedes the novelty set forth in the ‘characterized by’ clause. The novelty is meant to be particularly and distinctly recited in the ‘characterized by’ clause whereas the antecedent recitations merely set forth the old and well-known combination in which the invention resides. These antecedent recitations of prior art should be interpreted to cover any combination in which the inventive novelty exercises its utility.”,
storing as an antecedent explanation for antecedent checking and approximating “The use of the word ‘said’ in the claims refers to a previously-recited claimed feature and/or element (i.e. an antecedent) that is a positive recitation meant to be included in the coverage of the claims whereas the word ‘the’ precedes a previously-recited unclaimed feature and/or element that is not meant to be included in the coverage of the claims.”,
storing as a reference numerals disclaimer explanation approximating “In addition, the reference numerals in the claims are merely for convenience and are not to be read in any way as limiting.”,
characterized by scanning the claim for “characterized by” and “said” and reference numerals,
automatically inserting the characterized by explanation in the omnibus paragraph in response to “characterized by” being found in the claims,
automatically inserting the antecedent explanation in the omnibus paragraph in response to “said” being found in the claims,
automatically inserting the reference numerals disclaimer explanation in the omnibus paragraph in response to reference numerals being found in the claims.

10. A system for preparing a patent application including:
a CLAIMS section including a claim,
a DESCRIPTION section including an omnibus form paragraph,
said claim including a key,
a key explanation for explaining the use of said key in the patent application,
characterized by a scanning processor for parsing said claim for said key,
a key processor for inserting said key explanation in said omnibus form paragraph in response to said scanning processor detecting said key in said claim.

11. A system as set forth in claim 10 further including:
said claim including a second key,
a second key explanation for explaining the use of said second key in the patent application,
a second key processor for inserting said second key explanation in said omnibus form paragraph in response to said scanning processor detecting said second key in said claim.

12. A system as set forth in claim 10 further wherein said key is further defined by “characterized by.”

13. A system as set forth in claim 12 wherein said key explanation is further defined as a characterized by explanation.

14. A system as set forth in claim 13 wherein said characterized by explanation approximates “That which is prior art in the claims precedes the novelty set forth in the ‘characterized by’ clause. The novelty is meant to be particularly and distinctly recited in the ‘characterized by’ clause whereas the antecedent recitations merely set forth the old and well-known combination in which the invention resides. These antecedent recitations of prior art should be interpreted to cover any combination in which the inventive novelty exercises its utility.”

15. A system as set forth in claim 10 wherein said key is further defined by “said.”

16. A system as set forth in claim 15 wherein said key explanation is further defined as an antecedent explanation.

17. A system as set forth in claim 16 wherein said antecedent explanation approximates “The use of the word ‘said’ in the claims refers to a previously-recited claimed feature and/or element (i.e. an antecedent) that is a positive recitation meant to be included in the coverage of the claims whereas the word ‘the’ precedes a previously-recited unclaimed feature and/or element that is not meant to be included in the coverage of the claims.”

18. A system as set forth in claim 10 wherein said key is further defined as a reference numeral.

19. A system as set forth in claim 18 wherein said key explanation is further defines as a reference numerals disclaimer explanation.

20. A system as set forth in claim 19 wherein said reference numerals disclaimer explanation approximates “In addition, the reference numerals in the claims are merely for convenience and are not to be read in any way as limiting.”

21. A system as set forth in claim 10 wherein said omnibus form paragraph includes a first omnibus form paragraph sentence approximating “Obviously, many modifications and variations of the present invention are possible in light of the above teachings and may be practiced otherwise than as specifically described while within the scope of the appended claims.”

22. A system for preparing a patent application including:
a CLAIMS section including a claim,
said claim including a first key and a second key and a third key,
a first key explanation for explaining the use of said first key in the patent application,
a second key explanation for explaining the use of said second key in the patent application,
a third key explanation for explaining the use of said third key in the patent application,
a DESCRIPTION section including an omnibus form paragraph,
a first omnibus form paragraph sentence defined by “Obviously, many modifications and variations of the present invention are possible in light of the above teachings and may be practiced otherwise than as specifically described while within the scope of the appended claims.”,
said first key defined by “characterized by,”
said second key defined by “said,”
said third key being a reference numeral,
said first key explanation being further defined as a characterized by explanation and approximating “That which is prior art in the claims precedes the novelty set forth in the ‘characterized by’ clause. The novelty is meant to be particularly and distinctly recited in the ‘characterized by’ clause whereas the antecedent recitations merely set forth the old and well-known combination in which the invention resides. These antecedent recitations of prior art should be interpreted to cover any combination in which the inventive novelty exercises its utility.”,
said second key explanation being further defined as an antecedent explanation and approximating “The use of the word ‘said’ in the claims refers to a previously-recited claimed feature and/or element (i.e. an antecedent) that is a positive recitation meant to be included in the coverage of the claims whereas the word ‘the’ precedes a previously-recited unclaimed feature and/or element that is not meant to be included in the coverage of the claims.”,
said third key explanation being further defined as a reference numerals disclaimer explanation and approximating “In addition, the reference numerals in the claims are merely for convenience and are not to be read in any way as limiting.”,
characterized by a scanning processor for surveying said claim for said first key and said second key and said third key,
a first key processor for inserting said characterized by explanation in said omnibus form paragraph in response to said scanning processor detecting said first key in said claim,
a second key processor for inserting said antecedent explanation in said omnibus form paragraph in response to said scanning processor detecting said second key in said claim,
a third key processor for inserting said reference numerals disclaimer explanation in said omnibus form paragraph in response to said scanning processor detecting said third key in said claim.
